(19) United States
(12) Patent Application Publication
(10) Pub. No.: US 2003/0015215 A1
(43) Pub. Date: Jan. 23, 2003

(54) Polishing pad conditioner and application thereof

(76) Inventors: Chia-Lin Hsu, Taipei (TW); Teng-Chun Tsai, Hsinchu (TW); Shao-Chung Hu, Taipei (TW); Jiun-Sheng Chen, Yunlin Hsien (TW)

Correspondence Address: CHARLES C.H. WU & ASSOCIATES, Suite 710, 7700 IRVINE CENTER DRIVE, Irvine, CA, 92618-3043, US

(21) Appl. No.: 09/921,414

(22) Filed: Aug. 2, 2001

(30) Foreign Application Priority Data
Jul. 20, 2001 (TW) 90117785

(51) Int. Cl. B08B 3/02

(52) U.S. Cl. 134/1; 134/33; 134/34

(57) ABSTRACT

An apparatus of a polishing pad conditioner and a method thereof, wherein the apparatus comprises a high-pressure water pipe for transmitting water. The high-pressure pipe is connected to an end of an ultrasonic oscillator, and another end of the ultrasonic oscillator is connected to a water tank. A spraying structure located above the water tank ejects water in the form of a water knife. The ultrasonic oscillator provides energy to the high-pressure water and the water knife is utilized to clean residue off the polishing pad. The polishing pad conditioner moves in an opposite direction from that of the polishing pad to allow the water knife of the polishing pad conditioner to clean the entire surface area of the polishing pad.

### CROSS-REFERENCE TO RELATED APPLICATION

This application claims the priority benefit of Taiwan application serial no. 90117785, filed Jul. 20, 2001.

### BACKGROUND OF THE INVENTION

1. Field of Invention

The present invention relates generally to an apparatus used in semiconductor fabrication and a fabrication method thereof. More particularly, the present invention relates to a polishing pad conditioner and its application. The polishing pad conditioner utilizes a water knife to clean a polishing pad that is used in a chemical mechanical polishing (CMP) process.

2. Description of the Related Art

When semiconductor fabrication enters into a micro field, a chemical mechanical polishing (CMP) process becomes an important technique, such as in a copper conductive wire's fabrication. Before the development of the copper etching technique, the fabrication of a copper conductive wire was carried out by combining the damascene method with the CMP technique.

The basic steps of the CMP process comprises the following steps. A rough surface of a polishing pad is first provided, and a wafer is placed on the polishing pad. A rotation movement is performed to allow the polishing pad to polish the surface of the wafer in the presence of a polishing slurry, which contains slurry particles. There are two types of polishing pads, including a hard polishing pad and a soft polishing pad. The hard polishing pad is mainly made of polyurethane (PU), and the soft polishing pad is made of non-woven cloth. After the polishing pad is used for a period of time, the rough surface of the polishing pad will adhere a lot of residue; thus, the polishing rate is decreased. Therefore, a polishing pad conditioner is normally used to clean off the residue from the polishing pad. There are two types of polishing pad conditioners that are commonly used to clean the polishing pad. One is a diamond particle type polishing pad conditioner, and the other is a brush type polishing pad conditioner. The diamond particle type polishing pad conditioner is usually used to clean a hard polishing pad, and the brush type polishing pad conditioner is used to clean a soft polishing pad.

However, due to the hardness of the material, the two types of polishing pad conditioners described above will damage the surface of the polishing pad and decrease the lifetime of the polishing pad. Moreover, the diamond particles or the brushes can come off from the polishing pad conditioner onto the polishing pad. These particles or brushes can cause defects on the surface of the wafer in the CMP process, such as defects caused by scratching.

### SUMMARY OF THE INVENTION

It is an object of the present invention to provide an apparatus of a polishing pad conditioner and a fabrication method thereof. The apparatus comprises a high-pressure water pipe for transmitting water. The high-pressure pipe is connected to an end of an ultrasonic oscillator, and another end of the ultrasonic oscillator is connected to a water tank. A spraying structure located above the water tank ejects water in the form of a water knife. The ultrasonic oscillator provides energy to the high-pressure water, and the water knife sprays out as high-pressure water to clean residue on the polishing pad.

The present invention provides a method of cleaning a polishing pad by utilizing a polishing pad conditioner. The polishing pad conditioner moves in an opposite direction from the polishing pad to allow the water knife of the polishing pad conditioner to clean the entire surface area of the polishing pad.

From the above-mentioned, the polishing pad conditioner of the present invention utilizes a water knife formed by high-pressure water to clean the polishing pad. The polishing pad conditioners do not directly contact with the surface of the polishing pads like the conventional polishing pad conditioners. Therefore, the surface of the polishing pad can be cleaned without damaging the surface, and no diamond-type particles or brushes are left on the polishing pad to damage the wafer.

Both the foregoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1 is schematic diagram of a first type of polishing pad conditioner in accordance with a preferred embodiment of the present invention.

FIG. 2 is a schematic diagram of a second type of polishing pad conditioner in accordance with a preferred embodiment of the present invention.

FIG. 3 shows a first cleaning method of a polishing pad. FIG. 4 shows a second cleaning method of a polishing pad.

FIG. 5 shows a third cleaning method of a polishing pad

### DESCRIPTION OF THE PREFERRED EMBODIMENTS

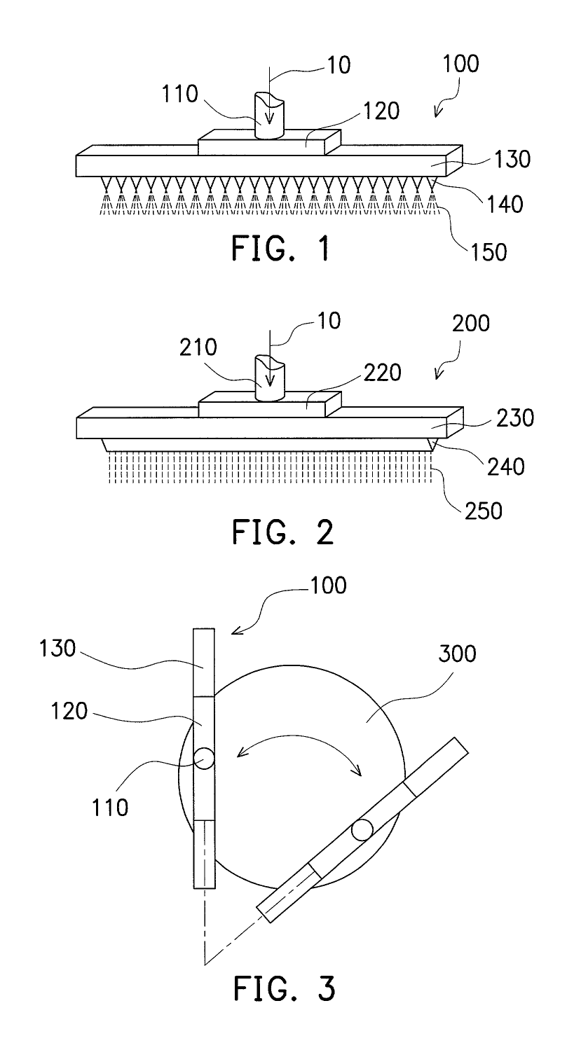

FIG. 1 illustrates a first type of polishing pad conditioner in accordance with a preferred embodiment of the present invention. Referring to FIG. 1, a polishing pad conditioner 100 comprises a high-pressure water pipe 110, an ultrasonic oscillator 120, a rectangular tank 130 and a plurality of spraying nozzles 140 that are arranged in a series. The high-pressure water pipe 110 is utilized for transmitting high-pressure water stream 10 at a flow rate of approximate 100 psi (pound per square inch), for example. The ultrasonic oscillator 120 is connected to one end of the high-pressure water pipe 110 and it has a frequency range of approximately between 20 kHz to 60 kHz. The energy supplied to the high-pressure water stream 10 is from the energy stored in the bubbles.

One end of the rectangular tank 130 is connected to the ultrasonic oscillator 120 and is utilized for storing the high-pressure water stream 10 that flows through the ultrasonic oscillator 120. The spraying nozzles 140 are located at another end of the rectangular tank 130. Water streams are sprayed out through very small holes of the nozzles 140, and due to the high pressure of the high pressure water stream 10 in the pipe 110, the water stream 10 is sprayed out like a water knife 150 in order to clean the polishing pad 300. However, positions of the spraying nozzles 140 have to be arranged close to each other, so that the water knife 150 can be sprayed out evenly and continuously on the whole polishing pad 300. The residue on the polishing pad 300 can then be removed easily.

FIG. 2 illustrates a second type of polishing pad conditioner in accordance with a preferred embodiment of the present invention. Referring to FIG. 2, the polishing pad conditioner 200 comprises a high-pressure pipe 210, an ultrasonic oscillator 220, a rectangular tank 230 and a spraying nozzle 240. The only difference between the first type of polishing pad and the second type of polishing pad is the nozzles. The water stream 10 is sprayed out like a water knife 250 through the nozzle 240, and the water stream 10 can be sprayed out evenly and continuously onto the polishing pad 300 in order to completely remove the residue.

The two types of polishing pad conditioners mentioned above both utilize the impact force produced from the water knife 150, 250 and the energy produced by the ultrasonic oscillators 120 and 220 to remove the residue off the polishing pad 300.

The ultrasonic oscillator first vibrates in the water to produce bubbles, and the energy produced from the ultrasonic oscillator is transferred and stored in the bubbles in the water. The formation of bubbles in the water causes a pressure change in the water. As a matter of fact, an inner pressure inside the bubbles is higher than an external pressure outside the bubbles. The bubbles will eventually burst to release the energy stored inside the bubbles. Therefore, the bubbles have a specific lifetime period. The energy released from the bubbles is transferred into the water.

The high-pressure water stream 10 is transmitted from the water tank 130/230 to the nozzles 140/240 and formed into the water knife 150/250. Some of the bubbles are still exited at the water knife 150/250, and the energy is released when the bubbles are burst. The energy is utilized to remove all the residue off the polishing pad.

However, the present invention is not limited to one method of removing the residue. The present invention provides three different methods to remove the residue off the polishing pad. However, the three methods have a common principle, which is to allow the polishing pad conditioner to move in an opposite direction from that of the water knife. Therefore, the residue can be completely removed off the polishing pads.

FIG. 3 illustrates a first cleaning method of a polishing pad. Referring to FIG. 3, a polishing pad 300 is fixed, and an axis along a rectangular-shaped water tank 130 (shown by a dotted line) is utilized to locate a center point. A polishing pad conditioner 100 utilizes its water knife (not shown) to polish the polishing pad 300 by rotating along the surface area of the polishing pad 300 with the center point as a rotation point. Therefore, the residue can be removed completely.

FIG. 4 illustrates a second cleaning method of a polishing pad. The polishing pad conditioner 100 is fixed, and the polishing pad 300 is rotated. The water knife (not shown) is moved along the surface area of the polishing pad 300 to remove all the residue. In actual application, the polishing pad 300 is located on a CMP machine, and the polishing pad conditioner 100 is positioned at a certain location. Then the polishing pad 300 is rotated. Referring to FIG. 4, a position 310 for locating a wafer shows the relative size of the polishing pad conditioner 100.

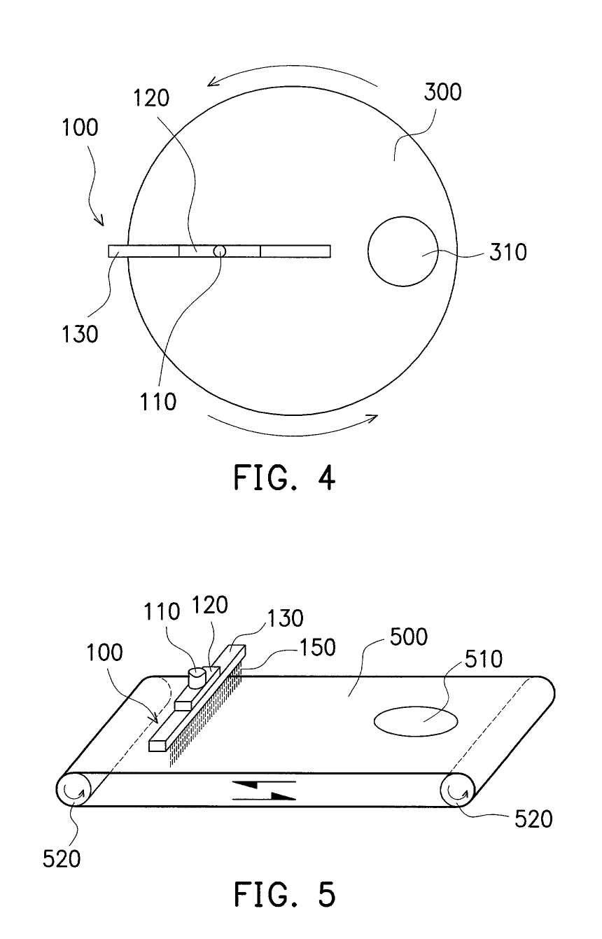

FIG. 5 illustrates a third cleaning method of a polishing pad. Referring to FIG. 5, a polishing pad 500 is a belt type polishing pad, which is different from the previous polishing pads. The polishing pad conditioner 100 is fixed, and a polishing pad 500 is positioned on a belt that is rotated by two rollers 520. Utilizing the movement of the belt, the water knife 150 cleans the entire surface area of the polishing pad 500 in order to remove the residue. In actual application, the polishing pad 500 is located on a belt of a CMP machine, and the polishing pad conditioner 100 is positioned at a certain location. The polishing pad 500 is moved along the belt. A position 510, which is shown in FIG. 5, is used to locate a wafer, and the position 510 shows the relative size of the polishing pad conditioner 100.

From the above-mentioned, the polishing pad conditioners of the present invention utilize the water knife formed by high-pressure water to clean the polishing pads. The polishing pad conditioners do not directly contact with the surface of the polishing pads like the conventional polishing pad conditioners. Therefore, the surface of the polishing pad can be cleaned without damaging the surface, and no diamond-type particles or brushes are left on the polishing pad to damage the wafer.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A polishing pad conditioner apparatus suitable for cleaning a polishing pad, the apparatus comprising:
a high-pressure pipe for importing high-pressure water;
an ultrasonic oscillator connected to one end of the high-pressure pipe, wherein the ultrasonic oscillator provides energy to the high-pressure water;
a water tank connected to the ultrasonic oscillator, wherein the water tank is used for storing the high-pressure water that passes through the ultrasonic oscillator.
a squirting structure located on top of the water tank, wherein the squirting structure ejects the high-pressure water in a water knife form, which is used to clean and remove residue off the polishing pad.

2. The apparatus of claim 1, wherein a pressure of the high-pressure water is about 100 psi.

3. The apparatus of claim 1, wherein a frequency range of the ultrasonic oscillator is approximately between 20 kHz to 60 kHz.

4. The apparatus of claim 1, wherein the water tank consists of a rectangular water tank.

5. The apparatus of claim 4, wherein the rectangular water tank comprises at least a row of spraying nozzles.

6. The apparatus of claim 5, wherein the spraying nozzles are arranged close to each other to eject the high-pressure water evenly and continuously.

7. The apparatus of claim 4, wherein the water tank further consists of a long shaped spraying nozzle, and a movement of the long-shaped spraying nozzle is parallel to the rectangular water tank.

8. A method of cleaning a polishing pad, the steps of the method comprising:
providing a polishing pad;
utilizing a polishing pad conditioner to clean the polishing pad, wherein the polishing pad conditioner moves in an opposite direction from that of the polishing pad, and the polishing pad conditioner cleans a whole surface of the polishing pad, wherein the polishing pad conditioner comprises:
a high pressure pipe for importing high-pressure water;
an ultrasonic oscillator connected to one end of the high-pressure pipe, wherein the ultrasonic oscillator provides energy to the high-pressure water;
a water tank connected to the ultrasonic oscillator, wherein the water tank is used for storing the high-pressure water that passes through the ultrasonic oscillator.
a squirting structure located on top of the water tank, wherein the squirting structure ejects the high-pressure water in a water knife form, which is used to clean and remove residue off the polishing pad.

9. The method of claim 8, wherein the step of the polishing pad conditioner to move relatively opposite direction as the polishing pad further comprising:
fixing the polishing pad;
aligning a position of the polishing pad conditioner to a position of the polishing pad; and
finding a center point near an axis of a rectangular water tank, the polishing pad conditioner is rotated parallel to a surface of the polishing pad so that the water knife clean off all residues.

10. The method of claim 8, wherein the step of utilizing the polishing pad conditioner to clean the polishing pad, the polishing pad conditioner moving in an opposite direction from that of the polishing pad further comprises:
fixing the polishing pad conditioner to align the water knife to the polishing pad; and
rotating the polishing pad for the water knife to clean the entire surface area of the polishing pad.

11. The method of claim 10, wherein the step of utilizing the polishing pad conditioner to clean the polishing pad, the polishing pad conditioner moving in an opposite direction from that of the polishing pad further comprises:
locating the polishing pad on a rotation type of a chemical mechanical polishing (CMP) machine;
positioning the polishing pad conditioner at a certain point that is above the polishing pad; and
starting the CMP machine to rotate the polishing pad.

12. The method of claim 8, wherein the step of utilizing the polishing pad conditioner to clean the polishing pad, the polishing pad conditioner moving in an opposite direction from that of the polishing pad further comprises:
locating the polishing pad on a belt of rollers;
fixing the polishing pad conditioner, and aligning the water knife to the polishing pad on the belt; and
starting the rollers to allow the water knife to clean the entire surface of the polishing pad.

13. The method of claim 12, wherein the step of utilizing the polishing pad conditioner to clean the polishing pad, the polishing pad conditioner moving in an opposite direction from that of the polishing pad further comprises:
locating the polishing pad on a belt of a chemical mechanical polishing (CMP) machine;
positioning the polishing pad conditioner at a certain point that is above the polishing pad; and
starting the CMP machine to allow the water knife to clean the entire surface of the polishing pad.

14. The method of claim 8, wherein the high-pressure water is about 100 psi.

15. The method of claim 8, wherein a frequency range of the ultrasonic oscillator is approximately between 20 kHz to 60 kHz.

16. The method of claim 8, wherein the rectangular water tank comprises at least a row of spraying nozzles.

17. The method of claim 16, wherein the spraying nozzles are arranged close to each other to eject the high-pressure water evenly and continuously.

18. The apparatus of claim 8, wherein the water tank further consists of a long shaped spraying nozzle, and a movement of the long-shaped spraying nozzle is parallel to the rectangular water tank.
